(19) United States
(12) Patent Application Publication
(10) Pub. No.: US 2010/0011404 A1
(43) Pub. Date: Jan. 14, 2010

(54) TV SOFTWARE UPGRADE USING TV INTERNET ADAPTER

(75) Inventors: LUDOVIC DOUILLET, Escondido, CA (US); Dipendu Saha, San Diego, CA (US); Nobukazu Sugiyama, San Diego, CA (US); George Edward Williams, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/172,641

(22) Filed: Jul. 14, 2008

(51) Int. Cl. H04N 7/173

(52) U.S. Cl. 725/127

(57) ABSTRACT

A TV Internet adapter receives an upgrade request for TV software, downloads an updated software image, and then changes mode through software emulation into a mass storage device from which the TV downloads the updated image.

### FIELD OF THE INVENTION

The present invention relates generally to updating TV software images using a TV Internet adapter.

### BACKGROUND OF THE INVENTION

The fusion of television with the Internet is a continuing goal that has spawned systems making it convenient for viewers to access content from both conventional TV sources and the Internet using a single TV chassis. In this way, the number of programs that can be made available to people using the familiar technology of television can be expanded enormously.

This fusion has also resulted increasing the computerization of TVs. This in turn means that TVs increasingly become software driven. Once a TV is vended its software, if it remains static, can become less capable than the software of newer TVs.

### SUMMARY OF THE INVENTION

A system includes a TV including a TV display and an Internet adapter module connected to the TV using an audio video link and a control link. The TV is configured to display video received from the module over the audio video link responsive to data carried on the control link. The module emulates an Internet interface to send Internet video to the TV at a first time, and furthermore the module, at a second time, ceases to emulate an Internet interface and instead emulates a mass storage device accessible by the TV to obtain software therefrom.

The TV may include a processor that can send a special message to the module indicating that the TV has obtained the software from the module. In response to the special message the module may cease to emulate a mass storage and instead emulate an Internet interface. The control link can be, without limitation, a universal serial bus (USB) link, and the module may be implemented by a set back box.

In another aspect, a tangible digital storage medium is readable by a module processor to present, to a component configured to execute updatable software, an emulation of an Internet interface, receive from the component information identifying the component, send the information to a server over the Internet, receive back from the server updated software for the component, present to the component an emulation of a mass storage device, and permit the component to access the updated software.

In another aspect, a method includes configuring a module to virtually appear to a display device as an Internet adapter communicating with the Internet. The method also includes communicating, over a multimedia link between the module and the display device, video data received by the module from the Internet and communicating, over a control link between the module and the display device and without user interaction, information identifying the display device. The information is provided to an Internet server. In response, the method receives, at the module, update software from the server. The update software is associated with the display device. The configuration of the module is changed to virtually appear to the display device as a mass storage device and to no longer appear as an Internet adapter. Then, the display device is enabled to access the update software.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic view of a non-limiting system in accordance with present principles; and

FIG. 2 is a flow chart of non-limiting logic which may be undertaken by a processor executing code elements stored on a computer readable medium.

### DETAILED DESCRIPTION OF THE PREFERRED EMBODIMENT

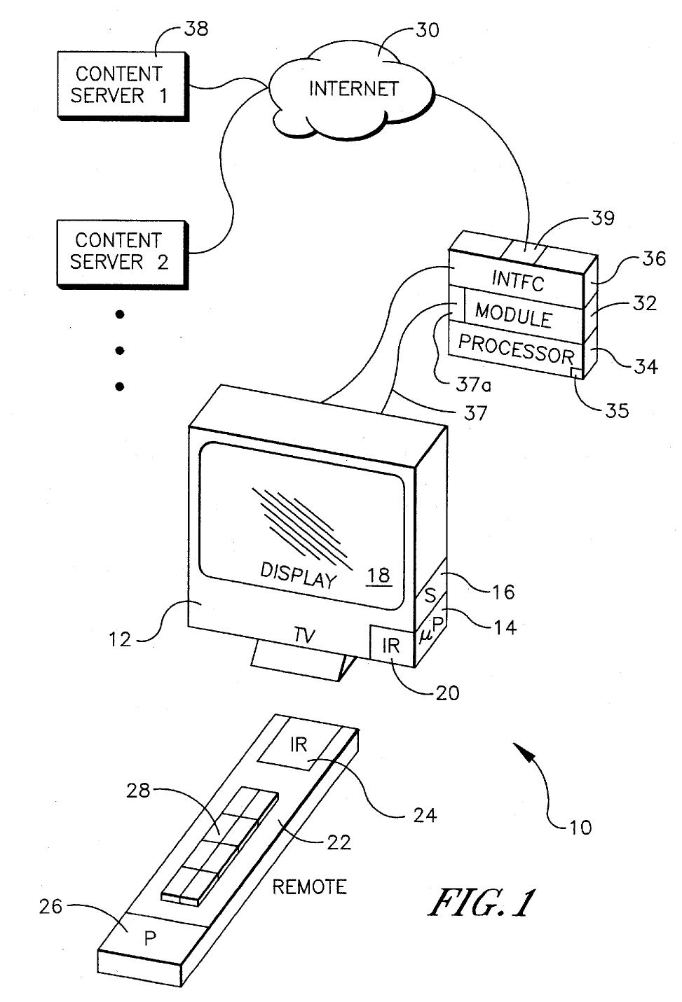

Referring initially to FIG. 1, a system is shown, generally designated 10, that includes a TV 12 with TV processor 14 and tangible digital storage medium 16 that may be, without limitation, a magnetic or optical disk drive, a solid state device such as random access memory or read-only memory or flash memory, a removable stick medium or removable floppy disk, etc. The medium 16 and processor 14 may be stored in the TV housing as shown along with a display 18 such as but not limited to a high definition (HD) matrix display or a standard definition cathode ray tube display, or the processor 14 and/or medium 16 may be external to the TV housing, e.g., in a set-top box or in the below-discussed module. Typically, the TV processor is programmed with code for receiving updates, a mechanism that is leveraged by the logic below.

The TV 12 typically includes a wireless receiver such as but not limited to an IR receiver 20 for receiving wireless signals from a hand-held remote control 22 having a wireless transmitter such as but not limited to an IR transmitter 24. A processor 26 in the remote control 22 can receive input from a user-manipulable key array 28 in accordance with principles known in the art to cause the transmitter 24 to send wireless signals to the TV 12, including cursor control signals to move a cursor on the display 18.

In the non-limiting embodiment shown in FIG. 1, audio-video content from a wide area computer network such as the Internet 30 can be provided to the TV 12 for presentation on the display 18 using a Internet adapter module 32 that may have a module processor 34 accessing a computer readable medium 35. The module 32 may communicate audio video data with the TV 12 using a communication interface 36 such as a high definition multimedia interface (HDMI) to provide content from the Internet to the TV. Also, the module 32 can exchange control information over a control link 37 with the TV by means of a control link interface 37a such as a universal serial bus (USB) interface. This control information may include commands and GUI elements used for display and user interaction.

The module 32, which can be implemented as a set-back box (SBB) or other device such as an optical disk player, may be physically engaged with the housing of the TV 12 with communication being established by respective connectors on the module and TV, or the module 32 may be connected via a cord to the TV 12. In any case, an Internet interface 39 (such as a wired or wireless modem) of the module 32 can be connected to the Internet typically by a computer cable that extends from the housing of the module 32 to an Internet jack, although as intimated above the module 32 alternatively may communicate with the Internet wirelessly using, e.g., Wi-Fi, WiMAX, etc. Audio-video content may be provided from one or more content servers 38 on the Internet 30 via the module 32 for presentation on the TV display 18.

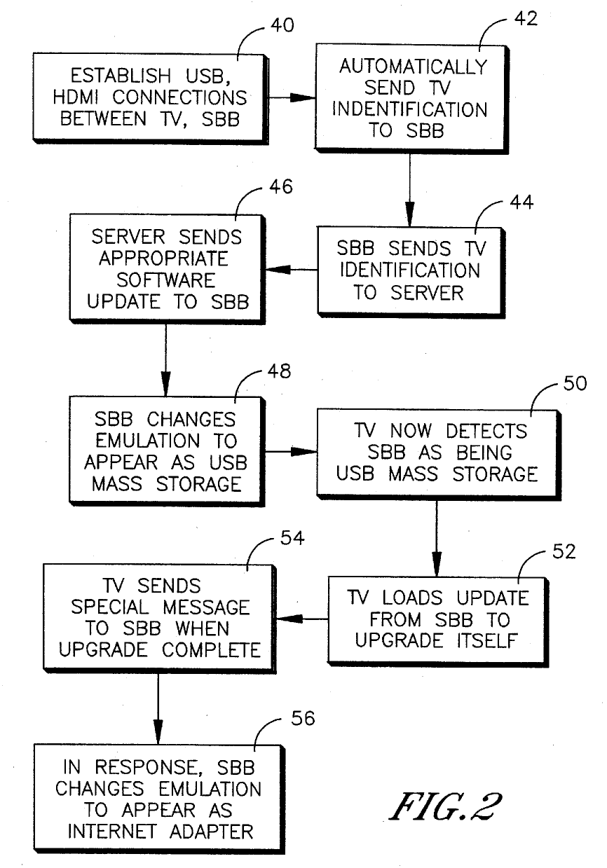

FIG. 2 shows logic in accordance with present principles. While FIG. 2 refers specifically to a TV that requires updating and a SBB that obtains software for upgrading the TV, general principles apply to updatable components other than the TV and updating components other than the SBB.

Commencing at block 40, the USB link 37 and, if desired, the HDMI connection are established between the module 32 and TV 12. At block 42, the TV automatically sends identifying data over the USB link to the module. This data may include TV model number and serial number. The TV identifying information can also be read by the module 32 from the HDMI key selection vector (KSV) of the TV, typically received on the HDMI path.

In turn, at block 44 the module 32 sends the TV ID information over, e.g., the Internet to a server such as one of the servers shown in FIG. 1 or another server on the wide area network. The server contains a database that correlates TV identifying information with available software updates, and if any are found by the server that correlate to the uploaded TV ID information, the server sends the appropriate update back to the module 32 at block 46 using, e.g., the Internet. The software update may be stored in the medium 35 within the module 32.

When the module receives the update, at block 48 it changes its software emulation from that of an Internet adapter to one of mass storage, so that it appears to the TV 12 as, e.g., a USB mass storage device. The TV accordingly detects the module 32 as a mass storage device at block 50, loading the software from the medium 35 in the module 32 to the TV medium 16 in the TV 12 at block 52. The TV processor 14 accesses the medium 16 to update its internal software, e.g., its operating system or other software image, accordingly.

As shown at block 54 in FIG. 2, the TV 12 sends a special message such as a predetermined file or other message to the module 32 to indicate completion of the update. In response, at block 56 the module 32 again changes its software emulation, this time appearing once again as an Internet network interface to the TV. Control information exchange appropriate for a network adapter may then be subsequently exchanged over the USB link.

The above information exchange between TV and module in blocks 42, 52, 54, and 56 may be over the USB link. Internet video is sent from the module 32 to the TV 12 over the HDMI link.

While the particular TV SOFTWARE UPGRADE USING TV INTERNET ADAPTER is herein shown and described in detail, it is to be understood that the subject matter which is encompassed by the present invention is limited only by the claims. For example, the module 32 may be, instead of or in addition to an Internet adapter, a video disk adapter to provide video disk capabilities to the TV, in which case the update data can be loaded from a disk in the adapter to the TV, with the adapter containing the above-described database of TV ID and TV update files as well as the update files themselves.

What is claimed is:

1. A system, comprising:
a TV including a TV display; and
at least one adapter module connected to the TV using an audio video link and a control link, the TV configured to display video received from the module over the audio video link responsive to data carried on the control link, the module emulating an interface to send video to the TV at a first time, the module at a second time ceasing to emulate an interface and emulating a mass storage device accessible by the TV to obtain software therefrom.

2. The system of claim 1, wherein the module emulates an Internet interface and obtains the software from the Internet.

3. The system of claim 1, wherein the module emulates a video disk interface and obtains the software from a disk engaged therewith.

4. The system of claim 1, wherein the TV includes a processor sending a special message to the module indicating that the TV has obtained the software from the module.

5. The system of claim 4, wherein in response to the special message the module ceases to emulate a mass storage and emulates an Internet interface.

6. The system of claim 1, wherein the control link is a universal serial bus (USB) link.

7. The system of claim 1, wherein the module is implemented by a set back box.

8. A tangible digital storage medium readable by a module processor to:
present, to a component configured to execute updatable software, an emulation of an Internet interface;
receive from the component information identifying the component;
send the information to a server over the Internet;
receive back from the server updated software for the component;
present to the component an emulation of a mass storage device; and
permit the component to access the updated software.

9. The medium of claim 8, wherein the component is a TV.

10. The medium of claim 9, wherein the module is implemented by a set back box.

11. The medium of claim 10, wherein the TV includes a processor sending a signal to the module indicating that the TV has obtained the updated software.

12. The medium of claim 11, wherein in response to the signal the module ceases to emulate a mass storage and emulates an Internet interface.

13. The medium of claim 8, wherein the module emulates, at different times, a USB mass storage device and a USB Internet adapter.

14. A method, comprising:
configuring a module to virtually appear to a display device as an Internet adapter communicating with the Internet;
communicating, over a multimedia link between the module and the display device, video data received by the module from the Internet;
communicating, over a control link between the module and the display device and without user interaction, information identifying the display device;
providing the information to an Internet server;
receiving, at the module, update software from the server, the update software being associated with the display device;
changing the configuration of the module to virtually appear to the display device as a mass storage device and to no longer appear as an Internet adapter; and
enabling the display device to access the update software.

15. The method of claim 14, wherein the module is a set box.

16. The method of claim 14, wherein the display device is a TV.

17. The method of claim 14, wherein the control link is a USB link.

18. The method of claim 14, comprising sending a signal from the display device to the module indicating that the update software has been accessed by the display device.

19. The method of claim 16, comprising, in response to the signal, configuring the module to virtually appear to the display device as an Internet adapter and to no longer appear as a mass storage device.
